(19) United States
(12) Patent Application Publication
(10) Pub. No.: US 2026/0333155 A1
(43) Pub. Date: Oct. 22, 2026

(54) RADIO BASE STATION

(71) Applicant: NTT DOCOMO, INC., Tokyo (JP)

(72) Inventors: Mio Nakamura, Tokyo (JP); Tianyang Min, Tokyo (JP); Souki Watanabe, Tokyo (JP)

(73) Assignee: NTT DOCOMO, INC., Tokyo (JP)

(21) Appl. No.: 19/113,197

(22) PCT Filed: Nov. 4, 2022
(86) PCT No.: PCT/JP2022/041184

§ 371 Date: Mar. 19, 2025

(51) Int. Cl. H04W 36/00; H04W 36/08

(52) U.S. Cl. CPC H04W 36/00835; H04W 36/0061; H04W 36/0069; H04W 36/087

(57) ABSTRACT

A radio base station comprises a first device and one or more second devices connected to the first device. The second device comprises a transmission unit that transmits to the first device a message including a report or proposal of maintaining or activating a candidate cell in the second device with respect to a terminal which maintains configuration of an addition/change procedure of a secondary cell without releasing it each time the addition/change procedure is executed. The first device comprises a reception unit that receives the message, and a control unit that executes processing according to the addition/change procedure, based on the report or proposal included in the message.

### TECHNICAL FIELD

This disclosure relates to a radio base station that supports an addition/change procedure of a secondary cell (secondary node).

### BACKGROUND ART

The 3rd Generation Partnership Project (3GPP: registered trademark) has prepared specifications of the 5th generation mobile communication system (5G, also referred to as New Radio (NR) or Next Generation (NG)), and is in the process of preparing specifications of the next generation referred to as Beyond 5G, 5G Evolution or 6G.

For example, 3GPP Release 17 specifies a conditional secondary cell addition/change (CPAC: conditional PSCell addition/change) procedure with a simplified procedure to achieve more efficient addition or change of primary SCell (PSCell).

Further, in 3GPP Release 18, regarding mobility enhancement of a terminal (User Equipment, UE) in NR-NR Dual Connectivity (NR-DC), a method (it may be referred to as selective activation) in which CPAC configuration is maintained without releasing it each time CPAC is executed, as necessary (Non-Patent Literature 1).

### CITATION LIST

### Non-Patent Literature

Non-Patent Literature 1:“Revised WID on Further NR mobility enhancements”, RP-222332, 3GPP TSG RAN Meeting #97 e, 3GPP, September 2022

### SUMMARY OF THE INVENTION

When selective activation is applied, the UE can maintain configuration of a candidate secondary cell of a transition destination after the CPAC is executed, which enables rapid cell transition and improves mobility of the UE.

However, for example, when a UE repeatedly moves between specific cells, more precise cooperation of information on the UE is required between a radio base station, specifically, a central unit (gNB-CU) and a distributed unit (gNB-DU), so that the UE continuously and efficiently executes a conditional secondary cell change (CPC: conditional PSCell change) procedure.

Therefore, the following disclosure has been made in view of such a situation, and an object of the disclosure is to provide a radio base station that contributes to achievement of more efficient CPAC when selective activation is applied.

An aspect of the present disclosure is a radio base station (gNB 100) including a first device and one or more second devices connected to the first device, in which the second device includes a transmission unit (F1 processing unit 170) that transmits to the first device a message including a report or proposal of maintaining or activating a candidate cell in the second device with respect to a terminal which maintains configuration of an addition/change procedure of a secondary cell without releasing it each time the addition/change procedure is executed; and the first device includes a reception unit that receives the message, and a control unit (control unit 140) that executes processing according to the addition/change procedure, based on the report or proposal included in the message.

An aspect of the present disclosure is a radio base station (gNB 100) including a first device and one or more second devices connected to the first device, in which the first device includes a transmission unit (F1 processing unit 130) that transmits to the second device a message including an indication to maintain or activate a candidate cell with respect to a terminal which maintains configuration of an addition/change procedure of a secondary cell without releasing it each time the addition/change procedure is executed; and the second device comprises a reception unit that receives the message, and a control unit (control unit 180) that maintains or activates the candidate cell, based on the indication included in the message.

An aspect of the present disclosure is a radio base station (gNB 100) including a first device and one or more second devices connected to the first device, in which the second device includes a transmission unit (F1 processing unit 170) that transmits to the first device a message including a report of maintaining terminal information in the second device with respect to a terminal which maintains configuration of an addition/change procedure of a secondary cell without releasing it each time the addition/change procedure is executed; and the first device includes a reception unit that receives the message, and a control unit (control unit 140) that executes processing according to the addition/change procedure, based on the report included in the message.

An aspect of the present disclosure is a radio base station (gNB 100) including a first device and one or more second devices connected to the first device, in which the first device includes a transmission unit (F1 processing unit 130) that transmits to the second device a message including an indication to maintain or discard terminal information with respect to a terminal which maintains configuration of an addition/change procedure of a secondary cell without releasing it each time the addition/change procedure is executed; and the second device includes a reception unit that receives the message, and a control unit (control unit 180) that maintains or discards the terminal information, based on the indication included in the message. An aspect of the present disclosure is a radio base station (gNB 100) including a reception unit (RRC/Xn processing unit 120) that receives from another radio base station a message including an indication to maintain or activate a candidate cell with respect to a terminal which maintains configuration of an addition/change procedure of a secondary cell without releasing it each time the addition/change procedure is executed; and a control unit (control unit 140) that executes processing according to the addition/change procedure, based on the indication included in the message.

An aspect of the present disclosure is a radio base station (gNB 100) including a reception unit (RRC/Xn processing unit 120) that receives from another radio base station a message including an indication to maintain or discard terminal information with respect to a terminal which maintains configuration of an addition/change procedure of a secondary cell without releasing it each time the addition/change procedure is executed; and a control unit (control unit 140) that executes processing according to the addition/change procedure, based on the indication included in the message.

### BRIEF DESCRIPTION OF THE DRAWINGS

FIG. 1 is an overall schematic configuration diagram of a radio communication system 10.

FIG. 2 is a diagram illustrating an example of a candidate cell list applied to CHO/CPAC.

FIG. 3 is a functional block configuration diagram of a gNB 100 (CU).

FIG. 4 is a functional block configuration diagram of the gNB 100 (DU).

FIG. 5 is a diagram illustrating an example of a sequence according to an MN initiated CPC based procedure.

FIG. 6 is a diagram illustrating a configuration example (part 1) of an F1AP message. FIG. 7 is a diagram illustrating an F1AP message configuration example (part 2).

FIG. 8 is a diagram illustrating an F1AP message configuration example (part 3).

FIG. 9 is a diagram illustrating an F1AP message configuration example (part 4).

FIG. 10 is a diagram illustrating an XnAP message configuration example (part 1).

FIG. 11 is a diagram illustrating an XnAP message configuration example (part 2).

FIG. 12 is a diagram illustrating an XnAP message configuration example (part 3).

FIG. 13 is a diagram illustrating an example of a hardware configuration of the gNB 100.

FIG. 14 is a diagram illustrating a configuration example of a vehicle 2001.

### DESCRIPTION OF EMBODIMENTS

Hereinafter, an embodiment will be described based on the drawings. It should be noted that the same or similar reference signs are assigned to the same function or configuration, and the description thereof will be omitted, as appropriate.

### (1) Overall Schematic Configuration of a Radio Communication System

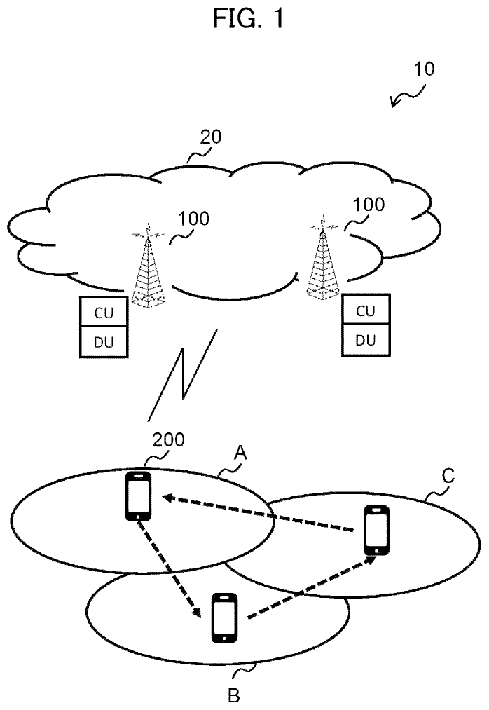

FIG. 1 is an overall schematic configuration diagram of a radio communication system 10 according to the present embodiment. The radio communication system 10 is a radio communication system in accordance with 5G New Radio (NR), and includes a Next Generation-Radio Access Network 20 (hereinafter, referred to as NG-RAN 20), and a terminal 200 (User Equipment 200, hereinafter, referred to as a UE 200).

The radio communication system 10 may be a radio communication system according to a method referred to as Beyond 5G, 5G Evolution or 6G, or may include a radio communication system according to a method referred to as Long Term Evolution (LTE) or 4G. The radio communication system 10 may support functions related to Industrial Internet of Things (IIoT) and URLLC (Ultra-Reliable and Low Latency Communications).

The NG-RAN 20 includes a radio base station 100 (gNB 100). A specific configuration of the radio communication system 10 including the number of gNBs (eNB or the like may be possible) and UEs is not limited to the example illustrated in FIG. 1.

The gNB 100 may also adopt a fronthaul (FH) interface specified by an O-RAN (Open Radio Access Network Alliance). The gNB 100 may include O-DU (O-RAN Distributed Unit) and O-RU (O-RAN Radio Unit). The gNB 100 may function as a kind of NG-RAN node.

The NG-RAN 20 includes in practice a plurality of NG-RAN nodes, specifically gNBs (or ng-eNBs), which are connected to a core network (5GC, not illustrated) in accordance with 5G. The 5 GC may introduce a concept of CUPS (Control and User Plane Separation), which clearly separates functions of a user plane and a control plane.

An Access and Mobility Management Function (AMF), which is included in a system architecture of the 5G and provides access and mobility management functions of the UE 200, and a Session Management Function (SMF), which provides a session management function, are connected to the NG-RAN 20. UDM (Unified Data Management) and/or UDR (User Data Repository) may be connected to the AMF and/or SMF. The NG-RAN 20 and the 5GC may be simply described as a “network”.

The gNB 100 is a radio base station according to the NR, and performs radio communication with the UE 200 according to the NR. The gNB 100 may include a CU (Central Unit, a first device) and a DU (Distributed Unit, a second device), and the DU may be separated from the CU, and installed at a geographically different location. One or more DUs may be connected to the CU. The gNB 100 (gNB-CU) may be connected by an Xn interface, and the CU and the DUs may be connected by an F1 interface.

The gNB 100 and the UE 200 can support Massive MIMO, which generates a beam with higher directivity, Carrier Aggregation (CA), which uses a plurality of component carriers (CCs) as a bundle, and Dual Connectivity (DC), which simultaneously communicates between the UEs and the plurality of NG-RAN Nodes, by controlling radio signals transmitted from a plurality of antenna elements.

In the present embodiment, a Multi-Radio Dual Connectivity (MR-DC), in which any gNB 100 of the plurality of gNBs 100 constitutes a master node (MN) and another gNB 100 constitutes a secondary node (SN) may be executed. Specifically, NR-NR Dual Connectivity (NR-DC), in which the gNBs constitute a MN (MgNB) and a SN (SgNB), may be executed. Alternatively, E-UTRA-NR Dual Connectivity (EN-DC) or NR-E-UTRA Dual Connectivity (NE-DC) may be executed.

Thus, the UE 200 supports dual connectivity for connecting the plurality of gNBs 100.

Any gNB 100 may be included in a master cell group (MCG), and other gNB 100 may be included in a secondary cell group (SCG). The other gNB 100 may be interpreted as SN included in the SCG. The gNB 100 may be referred to as radio base stations or network devices.

The radio communication system 10 may support conditional handover (CHO). The CHO may perform a UE 200 driven handover when certain execution conditions are met. If the CHO is not applicable, a normal handover may be performed (which may be referred to as CHO recovery). The radio communication system 10 may support conditional addition or change (conditional PSCell addition/change, CPAC) of a primary SCell (PSCell). A PSCell is a kind of secondary cell. The PSCell means a primary SCell (secondary cell). It may be interpreted that any of the plurality of SCells may correspond to the PSCell.

It should be noted that the secondary cell may be read as the secondary node (SN) or the secondary cell group (SCG). By a conditional PSCell addition/change, an efficient and rapid addition or change of a secondary cell can be achieved.

The conditional PSCell addition/change may be interpreted as a conditional secondary cell addition/change procedure with a simplified procedure. The conditional PSCell addition/change may mean either addition or change of a SCell.

In the CHO/the CPAC, a time for an SN (SgNB) to maintain context information of the UE 200 (which contains UE Context, dedicated RACH resource, and C-RNTI (Cell-Radio Network Temporary Identifier), which may be referred to as terminal information) may be controlled by a timer. The SN (SgNB) may discard UE Context, based on an explicit indication from an MN (MgNB) or timer expiration (as defined by the 3GPP TS). Further, a gNB-DU may discard UE Context based on an explicit indication from a gNB-CU or timer expiration (depending on implementation).

In the radio communication system 10, a method (hereinafter referred to as selective activation) may be applied in which CPAC configuration is maintained, as necessary, without being released for each execution of CPAC. The selective activation may be interpreted as a method to avoid or reduce signaling for reconfiguration by maintaining configuration (config) for CHO/CPAC, as necessary, instead of releasing the configuration for each execution of CHO/CPAC.

Details of CHO/CPAC configuration is not particularly limited, but generally include context information of the UE 200 (information required to establish a connection, such as used resource blocks and security-related information) related to CHO/CPAC. It should be noted that information of a candidate cell of a transition destination may be included.

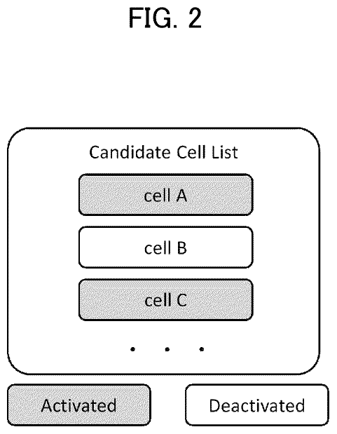

FIG. 2 illustrates an example of a candidate cell list applied to CHO/CPAC. As illustrated in FIG. 2, the candidate cell list applied to the CHO/CPAC includes a plurality of cells (for example, up to eight cells) and may include activated cells and deactivated cells. In particular, as illustrated in FIG. 1, when the UE 200 repeatedly moves between cells A to C, it may be preferable to maintain information of a specific cell (for example, cell B) without releasing (discarding) it.

In the radio communication system 10, when the selective activation is applied, in order to efficiently maintain context information of the UE 200 between the gNBs 100, specifically between CU and DUs, or MN (MgNB) and SNs (SgNB), and to efficiently maintain and activate/deactivate candidate cells, messages including special indications, reports, or proposals may be transmitted and received between CU and DUs, or MN to SNs.

### (2) Functional Block Configuration of the Radio Communication System

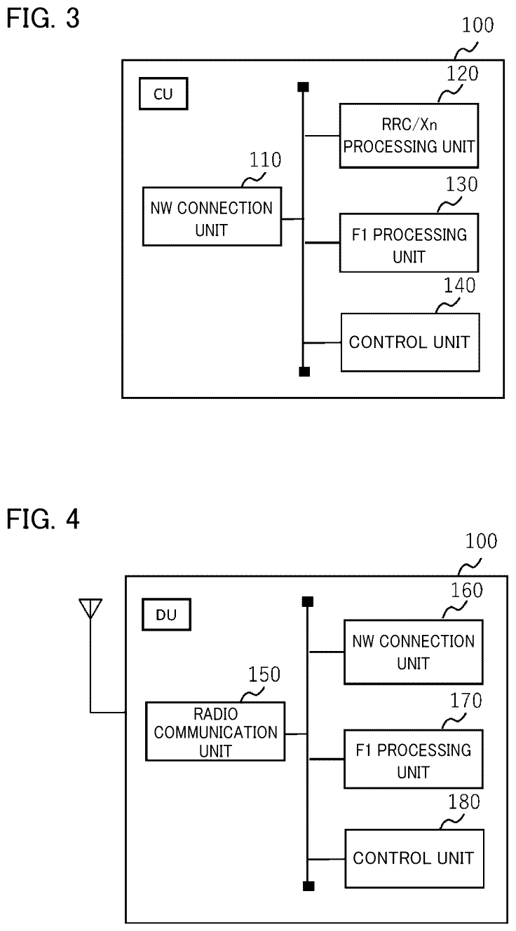

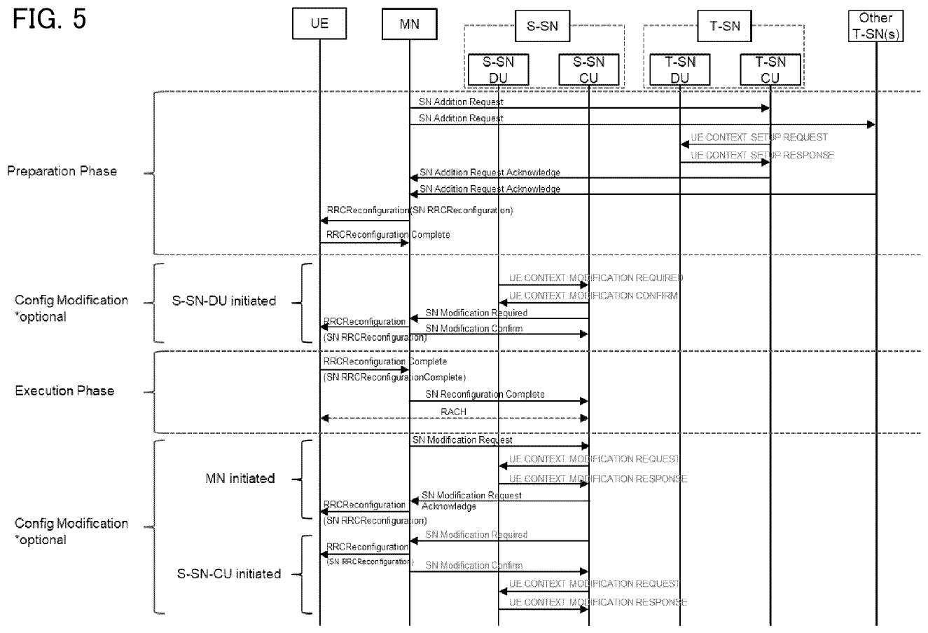

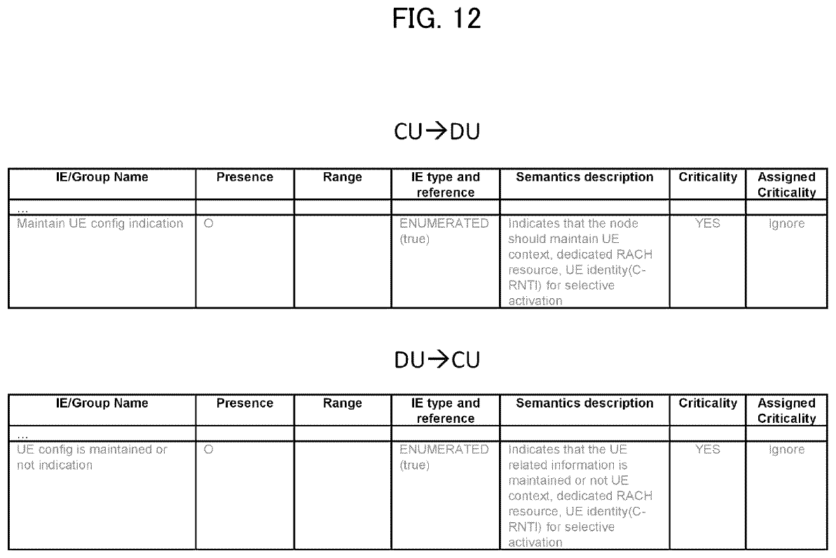

Next, a functional block configuration of the radio communication system 10 will be described. Specifically, the functional block configuration of the CU and DUs of the gNB 100 will be described. FIG. 3 is a functional block configuration diagram of the gNB 100 (CU). FIG. 4 is a functional block configuration diagram of the gNB 100 (DU). FIGS. 3 and 4 illustrate examples of main functional blocks related to the description of the embodiment, and the gNB 100 may have other functional blocks. FIGS. 3 and 4 illustrate the functional block configuration of the gNB 100 and UE 200. For the hardware configuration, refer to FIG. 12.

### (2.1) CU

The gNB 100 (CU) includes a NW connection unit 110, an RRC/Xn processing unit 120, an F1 processing unit 130, and a control unit 140.

The NW connection unit 110 provides interfaces, or the like, necessary for connection with other RAN nodes, and core network nodes constituting the network. In particular, in the present embodiment, the NW connection unit 110 can provide a connection interface (Xn) with other gNB 100 via the NG-RAN 20, and a connection interface (F1) with the DUs.

The RRC/Xn processing unit 120 executes various types of processing (XnAP) related to the Radio Resource Control Layer (RRC) and Xn interface. For example, the RRC/Xn processing unit 120 can send an RRC Reconfiguration to the UE 200. The RRC/Xn processing unit 120 can also receive an RRC Reconfiguration Complete, which is a response to the RRC Reconfiguration, from the UE 200.

The RRC/Xn processing unit 120 can send and receive inter-node messages via the Xn interface. For example, if the gNB 100 constitutes an MN, the RRC/Xn processing unit 120 may send and receive messages to and from the SN regarding changes to the SN. If the gNB 100 constitutes an SN, the RRC/Xn processing unit 120 may similarly send and receive messages to and from the MN regarding changes to the SN.

In the present embodiment, the RRC/Xn processing unit 120 may constitute a receiving unit that receives a message including an indication to maintain or activate a candidate cell related to the selective activation, that is, the UE 200 which maintains the CPAC configuration without releasing it each time the CPAC is executed, from other radio base stations (gNBs 100). The RRC/Xn processing unit 120 may constitute a receiving unit that receives a message including an indication to maintain or discard a UE Context (terminal information) related to the elective activation, that is, the UE 200 which maintains the CPAC configuration without releasing it each time the CPAC is executed, from other radio base stations (gNBs 100).

More specifically, the RRC/Xn processing unit 120 can process the following inter-node messages specified in the 3GPP TS 38.423 . The inter-node messages may include the above-described indication or the like.

(MN initiated Configuration: case where configuration is initiated by the MN)
SN Addition/Modification/Release Request (MN to SN)
SN Addition/Modification/Release Request Acknowledge (SN to MN)

(SN-DU initiated Config Modification: case where configuration is initiated by the DU in the SN)
SN Modification/Release Required (SN to MN)
SN Modification/Release Confirm (MN to SN)

(SN-CU initiated Config Modification: case where configuration is initiated by the CU in the SN)
SN Modification/Release Required (SN to MN)
SN Modification/Release Confirm (MN to SN)
   The F1 processing unit 130 executes various processing (F1AP) related to the F1 interface used for connection between CU and DU. Specifically, the F1 processing unit 130 can transmit and receive messages between CU and DUs via the F1 interface.

In the present embodiment, the F1 processing unit 130 may constitute a receiving unit that receives from the DU a message including a report or a proposal of maintaining or activating the candidate cell related to the UE 200 in the DU (second device). The F1 processing unit 130 may constitute a receiving unit that receives from the DU a message including a report of maintaining the UE Context (terminal information) related to the UE 200 in the DU (second device).

Further, the F1 processing unit 130 may constitute a transmitting unit that transmits to the DU (second device) a message including an indication to maintain or activate the candidate cell related to the selective activation, that is, the UE 200 which maintains the CPAC configuration without releasing it each time the CPAC is executed. The F1 processing unit 130 may configure a transmission unit that transmits to the DU (second device) a message including an indication to maintain or discard the UE Context (terminal information) related to the selective activation, that is, the UE 200 which maintains the CPAC configuration without releasing it each time the CPAC is executed.

More specifically, the F1 processing unit 130 may process the following message specified in the 3GPP TS 38.473 . The message may include the above-described indication or the like.

(MN initiated configuration: case where configuration is initiated by the MN)
UE Context Setup/Modification/Release Request (CU to DU)
UE Context Setup/Modification/Release Response (DU to CU)

(SN-DU initiated Config Modification: case where configuration is initiated by the DU in the SN)
UE Context Modification/Release Required (DU to CU)
UE Context Modification/Release Request/Command (CU to DU)

(SN-CU initiated Config Modification: case where configuration is initiated by the CU in the SN)
UE Context Modification/Release Request (CU to DU)
UE Context Modification/Release Response (DU to CU)
   The control unit 140 controls each functional block constituting the gNB 100 (CU). In particular, in the present embodiment, the control unit 140 can execute processing according to the CPAC based on a report or proposal included in an F1AP message specified in the 3GPP TS 38.473 . The control unit 140 can execute processing according to the CPAC, based on a report included in the F1AP message.

The control unit 140 can execute processing according to the CPAC, based on an indication included in the XnAP message (inter-node message) specified in the 3GPP TS38.423.

The processing according to the CPAC may include processing related to addition/change of a cell (SCell), the selective activation, or the like. As described above, the F1AP message and the XnAP message may include UE Context (terminal information), indication to maintain or discard a candidate cell, or the like.

It should be noted that, in the present embodiment, the channel may include a control channel and a data channel. The control channel may include PDCCH (Physical Downlink Control Channel), PUCCH (Physical Uplink Control Channel), PRACH (Physical Random Access Channel), PBCH (Physical Broadcast Channel), or the like.

Further, the data channel may include PDSCH (Physical Downlink Shared Channel), PUSCH (Physical Uplink Shared Channel), or the like.

It should be noted that the reference signal may include a Demonstration reference signal (DMRS), a Sounding Reference Signal (SRS), a Phase Tracking Reference Signal (PTRS), and a Channel State Information-Reference Signal (CSI-RS); and a signal include a channel and a reference signal. The data may mean data transmitted through a data channel.

### (2.2) DU

The gNB 100 (DU) includes a radio communication unit 150, a NW connection unit 160, an F1 processing unit 170, and a control unit 180.

The radio communication unit 150 transmits and receives radio signals in accordance with NR. Specifically, the radio communication unit 150 receives an uplink signal (UL signal) in accordance with NR from the UE 200, and transmits a downlink signal (DL signal) in accordance with NR to the UE 200.

The NW connection unit 160 can provide a connection interface (F1) with other RAN nodes constituting the network, in the present embodiment, the gNB 100 (CU).

The F1 processing unit 170, as well as the F1 processing unit 130 of the CU, executes various types of processing (F1 AP) related to the F1 interface used for the connection between the CU and the DUs. Specifically, the F1 processing unit 130 can transmit and receive messages between the CU and the DUs via the F1 interface.

In the present embodiment, the F1 processing unit 170 may constitute a transmission unit that transmits to the CU (first device) a message including a report or a proposal of maintaining or activating the candidate cell related to the selective activation in the DU (second device), that is, the UE 200 which maintains the CPAC configuration without releasing it each time the CPAC is executed,. The F1 processing unit 170 may constitute a reception unit that receives from the CU a message including an indication to maintain or activate the candidate cell related to the selective activation, that is, the UE 200 which maintains the CPAC configuration without releasing it each time the CPAC is executed.

The F1 processing unit 170 may constitute a transmission unit that transmits to the CU (first device) a message including a report of maintaining the UE Context (terminal information) related to the selective activation in the DU (second device), that is, the UE 200 which maintains the CPAC configuration without releasing it each time the CPAC is executed. The F1 processing unit 170 may constitute a reception unit that receives from the CU a message including an indication to maintain or discard the UE Context (terminal information) related to the selective activation, that is, the UE 200 which maintains the CPAC configuration without releasing it each time the CPAC is executed.

The F1 processing unit 170 may process a message specified in the 3GPP TS38.473, as described above. The message may include an indication described above, or the like.

The control unit 180 controls each functional block constituting the gNB 100 (DU). In particular, in the present embodiment, the control unit 180 can maintain or activate a candidate cell, based on an indication included in the F1AP message specified in the 3GPP TS 38.473.

The control unit 180 can maintain or discard the UE Context (terminal information), based on an indication included in the F1AP message specified in the 3GPP TS38.473.

The processing according to the CPAC may include processing related to addition/change of a cell (SCell), the selective activation, or the like. As described above, the F1AP message may include an indication to maintain or discard the UE Context (terminal information) and the candidate cell.

### (3) Operation of the Radio Communication System

Next, the operation of the radio communication system 10 will be described. Specifically, operation examples related to maintaining the UE Context (terminal information) and candidate cells between a CU and DUs, and between an MN and SNs related to the selective activation of the CPAC will be described.

### (3.1) Problems of Selective Activation

As illustrated in FIG. 1, when the UE 200 repeatedly moves between cells A to C, the following functional enhancements of the CPC (conditional PSCell change) can be considered in order to enable the UE 200 to continuously execute the CPC.
In Candidate T (Target)-SN, S (Source)-SN, the maintaining/discarding of the UE Context (or dedicated RACH resource/C-RNTI) or candidate cell (Candidate Cell) is indicated, proposed, or reported between CU and DUs.
In configuration of activation/deactivation of a candidate cell, a status of the candidate cell is indicated, proposed, or reported between CU and DUs.
Maintaining/discarding of UE Context (or dedicated RACH resource/C-RNTI) and a candidate cell is indicated, proposed, or reported between MN and SNs.

### (3.2) Example of Operation

In the selective activation, the following indication may be added to XnAP/F1AP in order to maintain the configuration information on the network side after CPAC execution. Alternatively, a new F1AP message may be added. The existing F1AP and XnAP messages to which the indication has been added may be called by different names.

### Existing Messages

F1AP: UE Context Setup/Modification/Release message
XnAP: SN Addition/Modification/Released message

### Function of Indication of Each Part

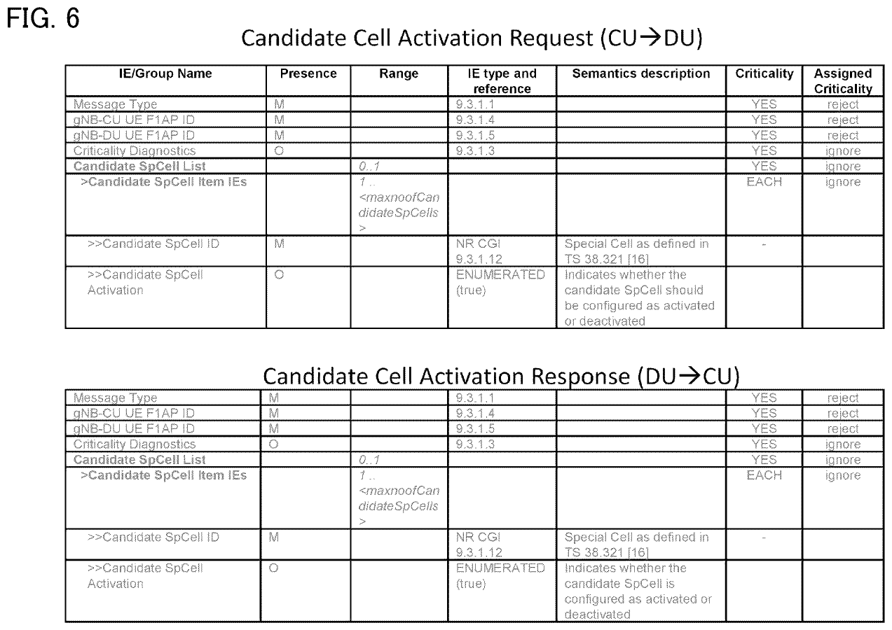

Indication to configure maintaining/discarding of a candidate cell
   DU: Report whether maintenance is possible or impossible, and propose discarding
   CU: Indicate maintaining/discarding
   MN/SN: Indicate or report mutual maintaining/discarding
Indication of an activated/deactivated candidate cell
   DU: Report and propose to activate/deactivate
   CU: Indicate to activate/deactivate
   MN/SN: Indicate or report to activate/deactivate to each other
Indication to configure maintaining/discarding of the UE Context
   DU: Report whether maintaining is possible or impossible, and propose discarding
   CU: Indicate maintaining/discarding
   MN/SN: Indicate or report maintaining/discarding to each other
      FIG. 5 illustrates an example of sequence according to the MN initiated CPC based procedure. As illustrated in FIG. 5, the procedure may include a Preparation Phase, a Config Modification and an Execution Phase.

In the Preparation Phase, the MN may indicate or report the UE to be maintained to the SN. In the Config Modification, the candidate cell may be updated between preparation and execution (FIG. 5 illustrates an SN-DU initiated example).

Alternatively, the candidate cell may be updated after execution (In FIG. 5, an MN initiated or SN-DU initiated example).

In the selective activation, the following indication may be added to the F1AP message in order to maintain information about the UE on the network side (all of the following UE Context Setup/Modification/Release may be considered).

### (1-1) Addition of Indication to Maintain and Discard a Candidate Cell Between CU and DUs, After the Next CPC

CU: indication, DU: report and proposal
   Setup Request←→Setup Response (report)
   Modification Request←→Modification Response (report)
   Modification Confirm←→Modification Required (Proposal)
   Release Command←→Release Request (Proposal)

### (1-2) Addition of Indication for Activating/Deactivating a Candidate Cell Between CU and DUs

CU: indication, DU: report and proposal
   Setup Request←→Setup Response (report)
   Modification Request←→Modification Response (report)
   Modification Confirm←→Modification Required (proposal)
   Release Command←→Release Request (proposal)

### (1-3) Addition of Indication to Maintain or Discard the UE Context After CPC Between CU and DUs

CU: indication, DU: report and proposal
   Setup Request←→Setup Response (report)
   Modification Request←→Modification Response (report)
   Modification Confirm←→Modification Required (proposal)
   Release Command←→Release Request (No addition of indication, operation according to existing 3GPP specifications)
      Further, in the selective activation, the following indication may be added to the XnAP message in order to maintain information about the UE on the network side (all SN Addition/Modification/Reconfiguration may be covered).

### (2-1) Addition of Indication Related to Maintaining and Discarding of the Candidate Cell After the Following CPC Between MN-SNs

MN: indication, SN: report and proposal
   Addition Request←→Addition Request Acknowledge (report)
   Modification Request←→Modification Request Acknowledge (report)
   Modification Confirm←→Modification Required (proposal)
   Reconfiguration Complete, Release Request/Acknowledge

### (2-2) Addition of Indication to Activate or Deactivate a Candidate Cell Between MN and SNs

MN: indication, SN: report and proposal
   Addition Request←→Addition Request Acknowledge (report)
   Modification Request←→Modification Request Acknowledge (report)
   Modification Confirm←→Modification Required (proposal)
   Reconfiguration Complete, Release Request/Acknowledge
      (2-3) Addition of Indication to Maintain or Discard the UE Context after CPC Between MN and SNs
MN: instruction, SN: report and proposal
   Addition Request←→Addition Request Acknowledge (report)
   Modification Request←→Modification Request Acknowledge (report)
   Modification Confirm←→Modification Required (proposal)
   Reconfiguration Complete, Release Request/Acknowledge

### (3.3) Message Configuration Example

Next, a configuration example of the F1AP message and the XnAP message will be described.

### (3.3.1) Example 1

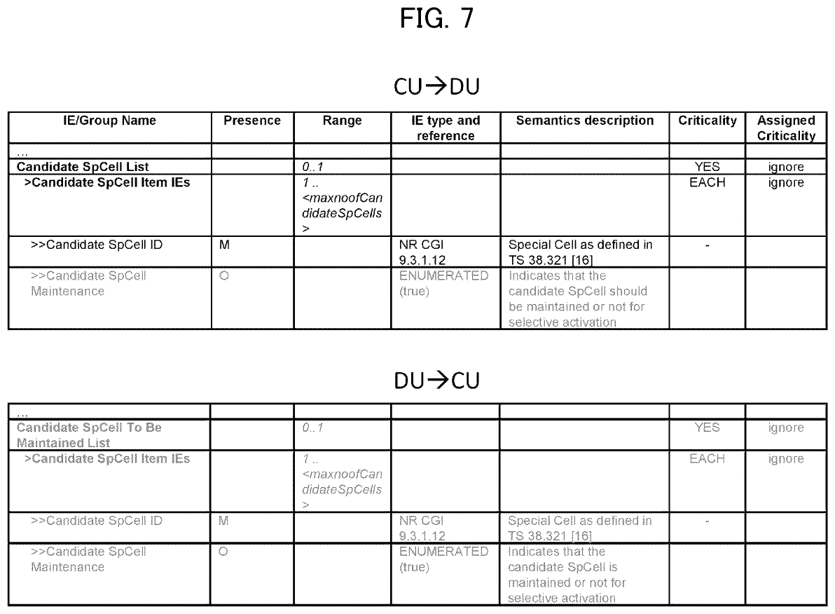

FIG. 6 illustrates a configuration example of an F1AP message (part 1). As illustrated in FIG. 6, a new F1AP message may be specified. Specifically, a message related to activate/deactivate a candidate cell may be added between CU and DUs.
CU: indication, DU: report
   Candidate Cell Activation Request←→Candidate Cell Activation Response
      Candidate Cell Activation Request and Candidate Cell Activation Response are tentative names, and other names may be used. As illustrated in FIG. 6, the IE of Candidate SpCell Activation may be included.

The Candidate Cell Activation Request and the Candidate Cell Activation Response may be transmitted in parallel with the existing F1AP message (if the existing F1AP message is required) or independently. This can reduce the message overhead.

### (3.3.2) Example 2

FIG. 7 illustrates a configuration example (part 2) of an F1AP message. As illustrated in FIG. 7, an indication (Candidate SpCell Maintenance) for maintaining and discarding the candidate cell may be added to an existing F1AP message after the next CPC (corresponding to (1-1) described above).

From a CU to DUs, an indication to indicate maintaining for each candidate cell may be added. From the DUs to the CU, an indication to report (or propose) maintenance may be added for each candidate cell.

### (3.3.3) Example 3

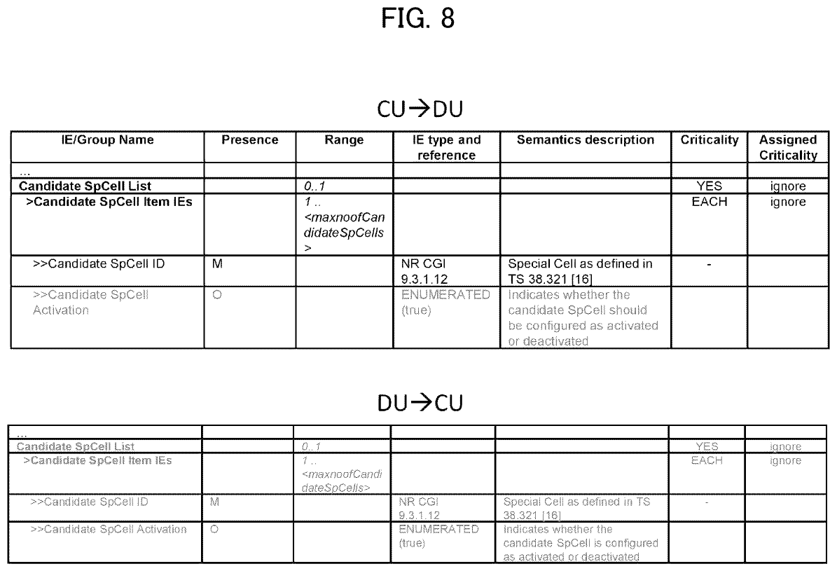

FIG. 8 illustrates a configuration example of an F1AP message (part 3). As illustrated in FIG. 8, an indication for an activated/deactivated candidate cell (Candidate SpCell Activation) may be added to the existing F1AP message (corresponding to (1-2) above).

From a CU to DUs, an indication indicating activation/deactivation may be added for each candidate cell. From the DUs to the CU, an indication to report (propose) activation/deactivation may be added for each candidate cell.

### (3.3.4) Example 4

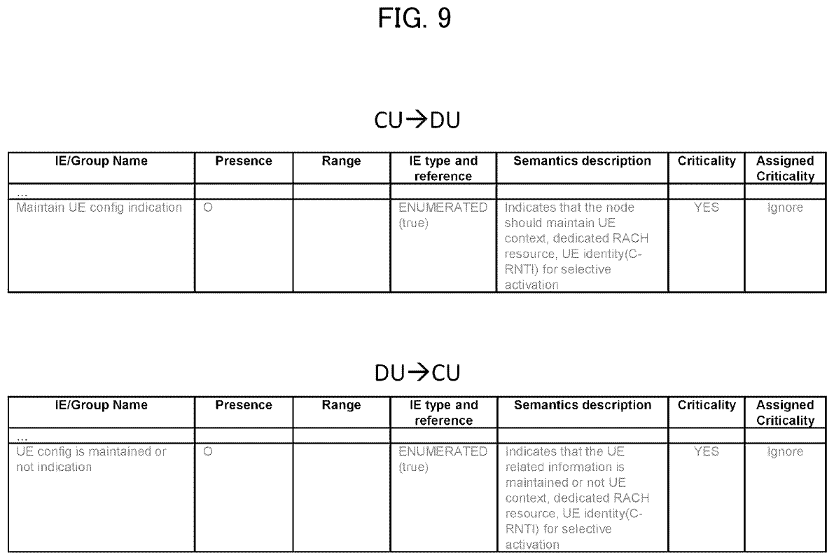

FIG. 9 illustrates a configuration example (part 4) of an F1AP message. As illustrated in FIG. 9, an indication (maintain UE config indication/UE config is maintained or not indication) related to maintaining the UE Context may be added to the existing F1AP message (corresponding to (1-3) described above).

From the CU to the DUs, an indication indicating maintaining configuration (config) for the UE may be added. From the DUs to the CU, an indication to report (or propose) maintenance of the configuration (config) for the UE may be added.

### (3.3.5) Example 5

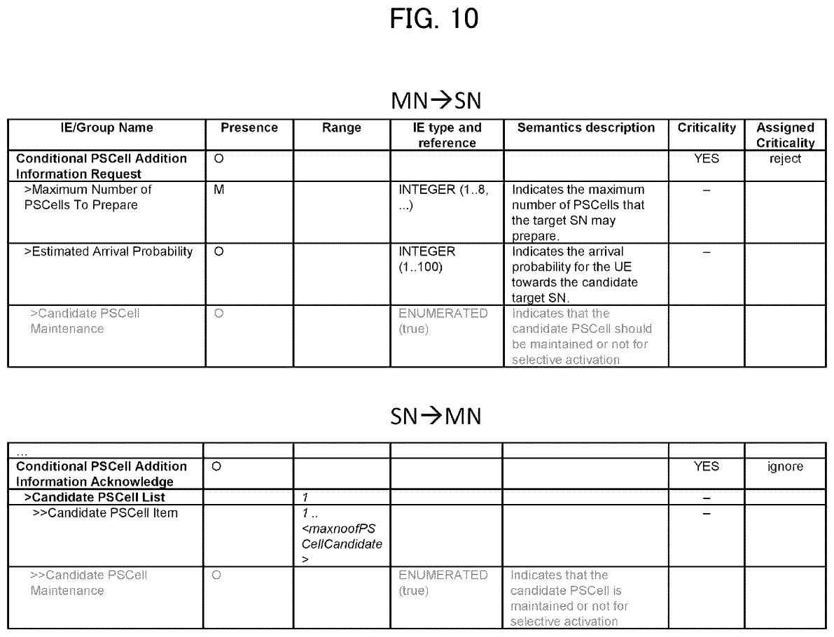

FIG. 10 illustrates an XnAP message configuration example (part 1). As illustrated in FIG. 10, an indication (Candidate SpCell Maintenance) regarding maintaining and discarding the candidate cell may be added to the existing XnAP message after the next CPC (corresponding to (2-1) described above).

From the MN to the SNs, an indication indicating maintenance may be added for each candidate cell. From the SNs to the MN, an indication indicating maintenance may be added for each candidate cell.

### (3.3.6) Example 6

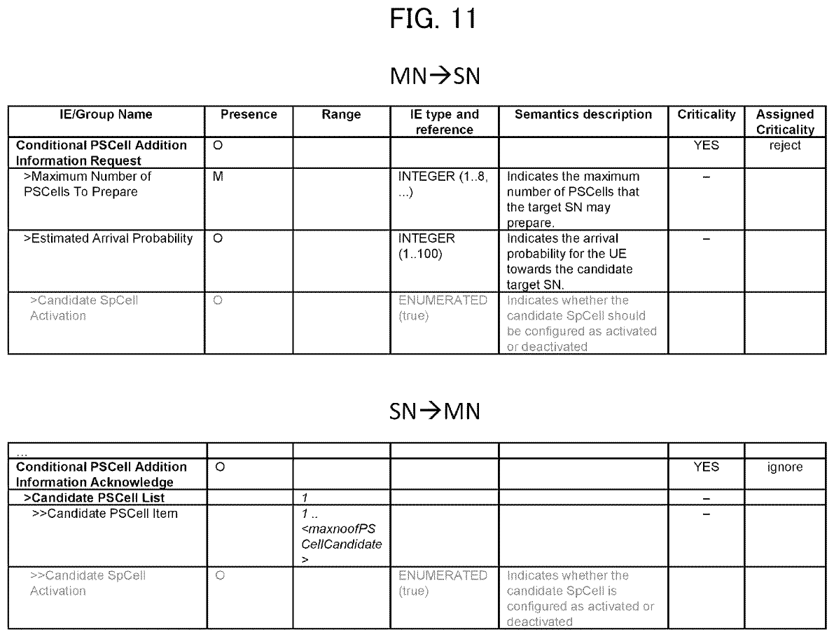

FIG. 11 illustrates an XnAP message configuration example (Part 2). As illustrated in FIG. 11, an indication indicating an activated/deactivated candidate cell (Candidate SpCell Activation) may be added to the existing XnAP message (corresponding to (2-2) above).

From the MN to the SNs, an indication indicating activation/deactivation may be added for each candidate cell. From the SNs to the MN, an indication to report (or propose) activation/deactivation may be added for each candidate cell.

### (3.3.7) Example 7

FIG. 12 illustrates an XnAP message configuration example (Part 3). As illustrated in FIG. 12, an indication (maintain UE config indication/UE config is maintained or not indication) related to the maintaining of the UE context may be added to the existing XnAP message (corresponding to (2-3) described above).

An indication indicating maintenance of configuration (config) for the UE may be added. From the DUs to the CU, an indication reporting (or proposing) maintaining of the configuration (config) for the UE may be added.

### (4) Operations and Effects

According to the embodiment described above, the following operations and effects can be obtained. Specifically, the gNB 100 can transmit and receive F1AP messages and XnAP messages including indications described above, so that it is possible to continuously implement handover (HO), cell change and addition without reconfiguration/re-initiation in the CHO/CPAC, thereby reducing the signaling overhead with the UE.

Moreover, even when the selective activation is applied, configuration is modified according to the load of the cell, or the like, as appropriate, so that the information about the UE to be maintained by the DUs or CU of the SN can be managed, as appropriate.

Thus, with the gNB 100 according to the present embodiment, even when the selective activation is applied and the UE repeatedly moves between a specific cells, the information about the UE can be maintained, as appropriate, and more efficient CPAC (and CHO) can be achieved.

### (5) Other Embodiments

Although the embodiments have been described above, embodiments are not limited to the embodiments described above, and it is obvious to those skilled in the art that various modifications and improvements can be made.

For example, in the embodiments described above, the CPAC is mainly described as an example, but the same operation may also be applied to the CHO.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

In the present disclosure, terms such as “precoding,” “precoder,” “weight,” “quasi-co-location (QCL),” “Transmission Configuration Indication state (TCI state),” “spatial relation,” “spatial domain filter,” “transmit power,” “phase rotation,” “antenna port,” “antenna port group,” “layer,” “number of layers,” “rank,” “resource,” “resource set,” “resource group,” “beam,” “beam width,” “beam angle,” “antenna,” “antenna element,” and “panel” may be used interchangeably.

The block diagram (FIGS. 3 and 4) used in the description of the above-described embodiment illustrates blocks in units of functions. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

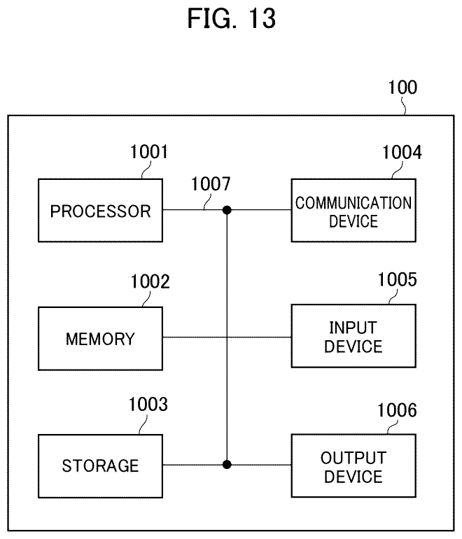

Further, the above-described gNB 100 (CU, DU) may function as a computer that performs processing of a radio communication method of the present disclosure. FIG. 13 is a diagram illustrating an example of a hardware configuration of the device. As illustrated in FIG. 13, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the gNB 100 (FIGS. 3 and 4) is implemented by means of any of hardware elements of the computer device or a combination of the hardware elements.

Each function in the gNB 100 is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the device may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these. According to the above, a case is described in which there is a single network node other than the base station 10. However, a combination of multiple other network nodes may be considered (e.g., MME and S-GW).

Information or signals (information and the like) may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any of a one of various different technologies. For example, data, an instruction, a command, information, a signal, a bit, a symbol, a chip, or the like, described throughout the present application, may be represented by a voltage, an electric current, electromagnetic waves, magnetic fields, magnetic particle, optical fields, a photon, or a combination thereof.

It should be noted that a term used in the present specification and/or term required for understanding of the present specification may be replaced by a term having the same or similar meaning. For example, a channel and a symbol may be a signal (signaling). Further a signal may also be a message. Further, the component carrier (CC) may be referred to as a carrier frequency, cell, frequency carrier, or the like.

As used in the present disclosure, the terms “system” and “network” are used interchangeably.

Furthermore, the information, parameters, and the like, described in the present disclosure may be expressed using absolute values, relative values from a predetermined values, or they may be expressed using corresponding different information. For example, a radio resource may be what is indicated by an index.

The names used for the parameters described above are not used as limitation. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a mobile station (hereinafter, a user terminal). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, mobile stations may have the functions of the base stations described above. The words such as “uplink” and “downlink” may be interpreted as the words corresponding to the terminal-to-terminal communication (for example, “side”). For example, an uplink channel, a downlink channel and so on may be interpreted as a sidelink channel (or sidelink).

Likewise, the mobile station in the present disclosure may be interpreted as base station. In this case, the base station may have the functions of the mobile station described above.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG), ”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

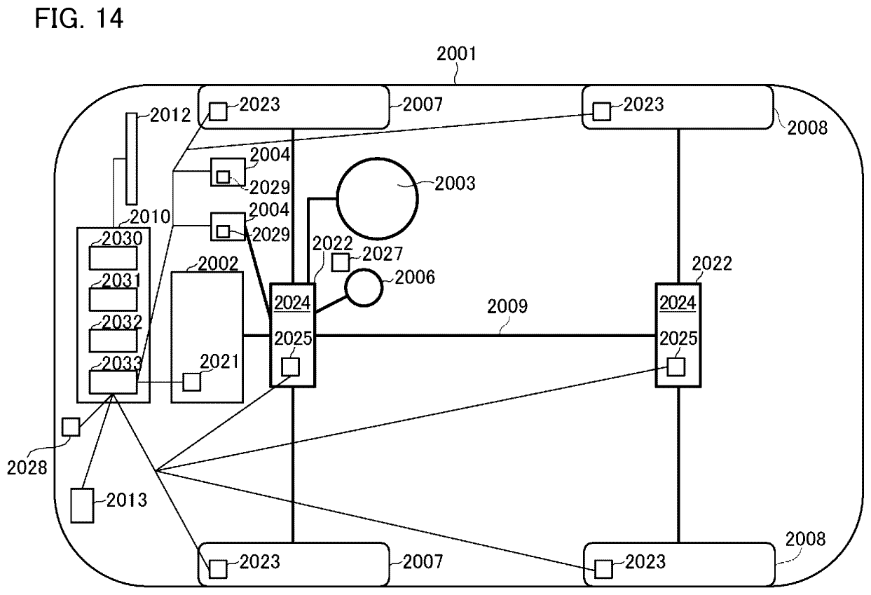

FIG. 14 shows a configuration example of a vehicle 2001. As shown in FIG. 14, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2027 provided in the vehicle. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal coming from a current sensor and input to the electronic control unit 2010 to an external device via radio communication. Further, the communication module 2013 transmits a rotation speed signal of a front wheel and a rear wheel acquired by the revolution sensor 2022, a pressure signal of a front wheel and a rear wheel acquired by a pneumatic sensor 2023, a speed signal of a vehicle acquired by a vehicle speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic control unit 2010 to an external device via radio communication.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
110 NW connection unit
120 RRC/Xn processing unit
130 F1 processing unit
140 Control unit
150 Radio communication unit
160 NW connection unit
170 F1 processing unit
180 Control unit
200 UE
1001 Processor
1002 Memory
1003 Storage
1004 Communication device
1005 Input device
1006 Output device
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port

1. A radio base station comprising a first device and one or more second devices connected to the first device, wherein:
the second device comprises a transmission unit that transmits to the first device a message including a report or proposal of maintaining or activating a candidate cell in the second device with respect to a terminal which maintains configuration of an addition/change procedure of a secondary cell without releasing it each time the addition/change procedure is executed; and
the first device comprises:
a reception unit that receives the message, and
a control unit that executes processing according to the addition/change procedure, based on the report or proposal included in the message.

2. A radio base station comprising a first device and one or more second devices connected to the first device, wherein:
the first device comprises a transmission unit that transmits to the second device a message including an indication to maintain or activate a candidate cell with respect to a terminal which maintains configuration of an addition/change procedure of a secondary cell without releasing it each time the addition/change procedure is executed; and
the second device comprises:
a reception unit that receives the message, and
a control unit that maintains or activates the candidate cell, based on the indication included in the message.

3. A radio base station comprising a first device and one or more second devices connected to the first device, wherein:
the second device comprises a transmission unit that transmits to the first device a message including a report of maintaining terminal information in the second device with respect to a terminal which maintains configuration of an addition/change procedure of a secondary cell without releasing it each time the addition/change procedure is executed; and
the first device comprises:
a reception unit that receives the message, and
a control unit that executes processing according to the addition/change procedure, based on the report included in the message.

4. A radio base station comprising a first device and one or more second devices connected to the first device, wherein:
the first device comprises a transmission unit that transmits to the second device a message including an indication to maintain or discard terminal information with respect to a terminal which maintains configuration of an addition/change procedure of a secondary cell without releasing it each time the addition/change procedure is executed; and
the second device comprises:
a reception unit that receives the message, and
a control unit that maintains or discards the terminal information, based on the indication included in the message.

5. A radio base station comprising:
a reception unit that receives from another radio base station a message including an indication to maintain or activate a candidate cell with respect to a terminal which maintains configuration of an addition/change procedure of a secondary cell without releasing it each time the addition/change procedure is executed; and
a control unit that executes processing according to the addition/change procedure, based on the indication included in the message.

6. A radio base station comprising:
a reception unit that receives from another radio base station a message including an indication to maintain or discard terminal information with respect to a terminal which maintains configuration of an addition/change procedure of a secondary cell without releasing it each time the addition/change procedure is executed; and
a control unit that executes processing according to the addition/change procedure, based on the indication included in the message.
